(19) United States
(12) Patent Application Publication
(10) Pub. No.: US 2011/0110581 A1
(43) Pub. Date: May 12, 2011

(54) 3D OBJECT RECOGNITION SYSTEM AND METHOD

(75) Inventors: Hyun Seung YANG, Daejeon (KR); Kyu Sung CHO, Daejeon (KR); Jae Sang YOO, Daejeon (KR); Jin Ki JUNG, Seoul (KR)

(73) Assignee: KOREA ADVANCED INSTITUTE OF SCIENCE AND TECHNOLOGY, Daejeon (KR)

(21) Appl. No.: 12/912,211

(22) Filed: Oct. 26, 2010

(30) Foreign Application Priority Data
Nov. 9, 2009 (KR) 10-2009-0107621

(51) Int. Cl. G06K 9/00

(52) U.S. Cl. 382/154

(57) ABSTRACT

Disclosed herein is a three-dimensional (3D) object recognition system and method. The 3D object recognition system includes a storage unit for storing an extended randomized forest in which a plurality of randomized trees is included and each of the randomized trees includes a plurality of leaf nodes, training means for extracting a plurality of keypoints from a training target object image, and calculating and storing an object recognition posterior probability distribution and training target object-based keypoint matching posterior probability distributions, and matching means for extracting a plurality of keypoints from a matching target object image, matching the extracted keypoints to a plurality of leaf nodes, recognizing an object using the object recognition posterior probability distributions, and matching the keypoints to keypoints of the recognized object using training target object-based keypoint matching posterior probability distributions stored at the matched leaf nodes.

### BACKGROUND OF THE INVENTION

1. Field of the Invention

The present invention relates generally to a three-dimensional (3D) object recognition system and method, and, more particularly, to a 3D object recognition system and method which is capable of simultaneously performing keypoint matching and object recognition using a generic randomized forest.

2. Description of the Related Art

The present invention is a technology which corresponds to the brains of service robots which will be commercialized in the future. For robots to carry out given duties, object recognition is essential. For example, when the instruction “go to a refrigerator and bring a coke can” is issued to a robot, object recognition, such as the recognition of the refrigerator, the recognition of a grip and the recognition of a coke can, is required.

Since the 1970s, the object recognition technology has been actively researched when many practical computers appeared. In the 1980s, the object recognition technology was the technology based on two-dimensional (2D) shape matching, and was chiefly used for the inspection of parts in the field of industrial vision. Since the end of the 1980s, the 3D model-based object recognition technology has been actively researched. In particular, the alignment technique has been successfully applied to the recognition of 3D polyhedrons. Since the mid-1990s, the image-based technique has slowly appeared, and then research into object recognition was started in earnest. An example thereof is an object recognition technique using a main component analysis scheme, such as PCA.

However, the conventional alignment technique has the limitation that it can work only for polyhedrons having many rectilinear components, and the conventional image-based method has the problem of being sensitive to changes in environment, such as a change in illumination, because it does not directly use pixel values for recognition. In particular, the conventional methods have the problem of being sensitive to covering or background noise because they are based on entire shape matching and have the problem of being very inefficient because object recognition and tracking are separately treated and therefore separately performed.

In order to overcome the above problem, the applicant of the present application applied for a patent for a technology for an object recognition and tracking method on Sep. 16, 2003, and a patent was issued to the technology on Oct. 27, 2005 (Korean Patent No. 10-0526018; hereinafter referred to as a “preceding patent”). The invention disclosed in the preceding patent is configured to set the correlations between model images captured by photographing objects and CAD models, that is, the appearances of the objects, calculate the Zernike moments the model images, and put them into a database. The invention is further configured to, when an image including an object is input, calculate the Zernike moment of the input image, calculate the matching probability between the Zernike moments of the model images put into the database and the Zernike moment of the input image, and then recognize the object included in the input image. Furthermore, an initial position is estimated by matching a CAD model to the input image. The motion of the object is tracked using a matched pair between the input image and the CAD model.

However, the invention disclosed in the preceding patent has the problems of a large amount of data, a complicated computational equation and a long processing time because a CDA model, that is, the appearance of an object, must be created in addition to a model image obtained by capturing the object and the position and motion of the object must be estimated by matching an input image to the CAD model.

### SUMMARY OF THE INVENTION

Accordingly, the present invention has been made keeping in mind the above problems occurring in the prior art, and an object of the present invention is to provide a 3D object recognition system and method which is capable of estimating the location and position of an object by performing object recognition and keypoint matching using only input images from a camera.

In order to accomplish the above object, the present invention provides a 3D object recognition system, including a storage unit for storing an extended randomized forest in which a plurality of randomized trees is included and each of the randomized trees includes a plurality of leaf nodes; training means for extracting a plurality of keypoints from a training target object image input for each of a plurality of training target objects, calculating an object recognition posterior probability distribution and training target object-based keypoint matching posterior probability distributions for each of the leaf nodes by applying the extracted keypoints to the extended randomized forest, and storing them in the storage unit; and matching means for extracting a plurality of keypoints from a matching target object image, matching the extracted keypoints to a plurality of leaf nodes by applying the extracted keypoints to the extended randomized forest, recognizing an object included in the matching target object image using the object recognition posterior probability distributions stored at the matched leaf nodes, and matching the keypoints extracted from the matching target object image to keypoints of the recognized object using training target object-based keypoint matching posterior probability distributions stored at the matched leaf nodes.

According to another embodiment of the present invention, there is provided a 3D object recognition system, including a storage unit for storing an extended randomized forest in which a plurality of randomized trees is included, each of the randomized trees includes a plurality of leaf nodes, and an object recognition posterior probability distribution and training target object-based keypoint matching posterior probability distributions are stored for each of the leaf nodes; and matching means for matching a plurality of keypoints, extracted from a matching target object image, to a plurality of leaf nodes by applying the extracted keypoints to the extended randomized forest, recognizing an object included in the matching target object image using object recognition posterior probability distributions stored at the matched leaf nodes, and matching the keypoints, extracted from the matching target object image, to keypoints of the recognized object using training target object-based keypoint matching posterior probability distributions stored at the matched leaf nodes.

According to another embodiment of the present invention, there is provided a 3D object recognition method for a 3D object recognition system including an extended randomized forest in which a plurality of randomized trees is included and each of the randomized trees includes a plurality of leaf nodes, including a training step of extracting a plurality of keypoints from a training target object image input for each of a plurality of training target objects, and calculating and storing an object recognition posterior probability distribution and training target object-based keypoint matching posterior probability distributions for each of the leaf nodes by applying the extracted keypoints to the extended randomized forest; and a matching step of matching a plurality of keypoints, extracted from a matching target object image, to a plurality of leaf nodes by applying the extracted keypoints to the extended randomized forest, recognizing an object included in the matching target object image using object recognition posterior probability distributions stored at the matched leaf nodes, and matching the keypoints extracted from the matching target object image to keypoints of the recognized object using training target object-based keypoint matching posterior probability distributions stored at the matched leaf nodes.

According to still another embodiment of the present invention, there is provided a 3D object recognition method for a 3D object recognition system including an extended randomized forest in which a plurality of randomized trees is included, each of the randomized trees includes a plurality of leaf nodes, and an object recognition posterior probability distribution and training target object-based keypoint matching posterior probability distributions are stored for each of the leaf nodes, including a step of matching a plurality of keypoints, extracted from a matching target object image, to a plurality of leaf nodes by applying the extracted keypoints to the extended randomized forest; a step of recognizing an object included in the matching target object image using object recognition posterior probability distributions stored at the matched leaf nodes; and a step of matching the keypoints, extracted from the matching target object image, to keypoints of the recognized object using training target object-based keypoint matching posterior probability distributions stored at the matched leaf nodes.

According to yet another embodiment of the present invention, there is provided a training method for 3D object recognition for a 3D object recognition system including an extended randomized forest in which a plurality of randomized trees is included and each of the randomized trees includes a plurality of leaf nodes, including a step of extracting a plurality of keypoints from a training target object image input for each of a plurality of training target objects; and a step of calculating an object recognition posterior probability distribution and training target object-based keypoint matching posterior probability distributions for each of the leaf nodes by applying the extracted keypoints to the extended randomized forest.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a functional block diagram of a 3D object recognition system according to the present invention;

FIG. 2 is a diagram showing an extended randomized forest according to the present invention;

FIG. 3 is a diagram showing a process of extracting keypoints using a FAST detector;

FIG. 4 is a diagram showing training data sets obtained by performing affine transformations on Nc training target object images;

FIG. 5 is a diagram showing training data sets obtained by performing affine transformations on respective keypoint regions;

FIG. 6 is a flowchart showing a process of training objects using training target object images according to the present invention;

FIG. 7 is a flowchart showing a process of training the keypoints of objects using training target object images according to the present invention;

FIG. 8 is a flowchart showing a process of recognizing an object included in a matching target object image and matching keypoints according to the present invention;

FIG. 9 is a graph illustrating the results of performance tests;

FIG. 10 is a diagram showing images of 44 pages used for 3D object recognition tests; and

FIG. 11 is a graph illustrating the times required for the sequential recognition of a book including 11 pages.

### DESCRIPTION OF THE PREFERRED EMBODIMENTS

Reference now should be made to the drawings, in which the same reference numerals are used throughout the different drawings to designate the same or similar components.

A 3D object recognition system and method according to an embodiment of the present invention will be described with reference to the accompanying drawings.

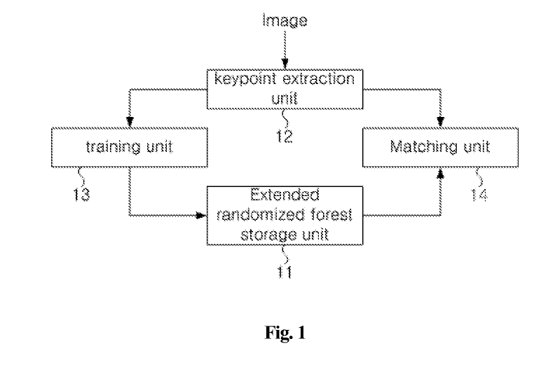

FIG. 1 is a functional block diagram of a 3D object recognition system according to the present invention. The 3D object recognition system according to the present invention includes an extended randomized forest storage unit 11, a keypoint extraction unit 12, a training unit 13, and a matching unit 14.

Extended Randomized Forest

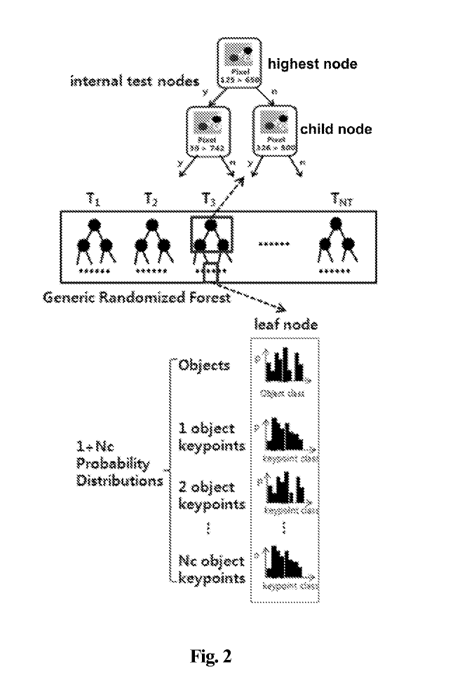

The present invention is based on technology which makes use of the randomized forest. The randomized forest is an algorithm which is commonly used to correct the position of an object by performing matching to find the portion of the object to which a partial image region (keypoint region), including a keypoint, belongs. The present invention extends the randomized forest, and simultaneously performs both object recognition and keypoint matching by simultaneously recognizing an object to which an input keypoint region belongs and recognizing the keypoint of the corresponding object to which the corresponding input keypoint region is matched. For this purpose, an extended randomized forest is created and is then stored in the extended randomized forest storage unit 11. The extended randomized forest includes a plurality of randomized trees T₁, T₂, . . . , and T_{NT}, as shown in FIG. 2. Each of the plurality of randomized trees is a complete binary tree. Each randomized tree includes multilayer nodes. The lowest node of each randomized tree is referred to as a leaf node. At each leaf node, information, including the number of times an arbitrary object is matched to the corresponding leaf node and the probability of the arbitrary object being matched to the corresponding leaf node and the number of times an arbitrary keypoint of the arbitrary object is matched to the corresponding leaf node and the probability of the arbitrary keypoint of the arbitrary object being matched to the corresponding leaf node, is stored through the training process, which will be described below.

Portion ‘A’ of FIG. 2 is a portion in which a plurality of nodes constituting a randomized tree is enlarged and then illustrated. Two arbitrary pixels constituting an input keypoint region are selected, the pixel values of the two corresponding pixels are compared with each other, and, if the pixel value of a first pixel is greater than that of a second pixel, the process proceeds to a right child node, and otherwise the process proceeds to a left child node. For example, at the highest node of FIG. 2, a 125 pixel and a 650 pixel are selected, and, if the pixel value of the 125 pixel is greater than that of the 650 pixel, the process proceeds to a right child node, and otherwise the process proceeds to a left child node. At the right child node of the highest node, the 36 pixel and the 742 pixel are selected, and the pixel values thereof are compared with each other. At the left child node of the highest node, a 326 pixel and a 500 pixel are selected, and the pixel values thereof are compared with each other. Here, a pixel value may be selected from among various values, including the color value of a specific color, and the grayscale value, luminance value, saturation value and brightness value of a corresponding pixel.

The extended randomized forest of the present invention includes 40 independent randomized trees each having a depth of 10. The numbers and pixel values of two pixels selected from each of the nodes constituting the extended randomized forest are randomly set and created, and the created extended randomized forest is stored in the extended randomized forest storage unit 11.

Extraction of Keypoints

The keypoint extraction unit 12 receives an image of a training target object and the boundary and length of the object at a training step, and extracts keypoints from the image of the training target object. Furthermore, the keypoint extraction unit 12 extracts keypoints from an image of a matching target object at a matching step. An algorithm for extracting keypoints from an image of a training target object is the same as an algorithm for extracting keypoints from an image of a matching target object. The keypoints extracted by the keypoint extraction unit are corner points. In an embodiment of the present invention, keypoints are extracted using a FAST detector. A detailed description of this Fast detector is given in the paper “Machine training for high-speed corner detection, Department of Engineering, Cambridge University, UK” by Edward Rosten and Tom Drummond. This FAST detector is based on a simple algorithm, and requires only about 2 ms to extract keypoints from a two-dimensional (2D) image of 640*480 size.

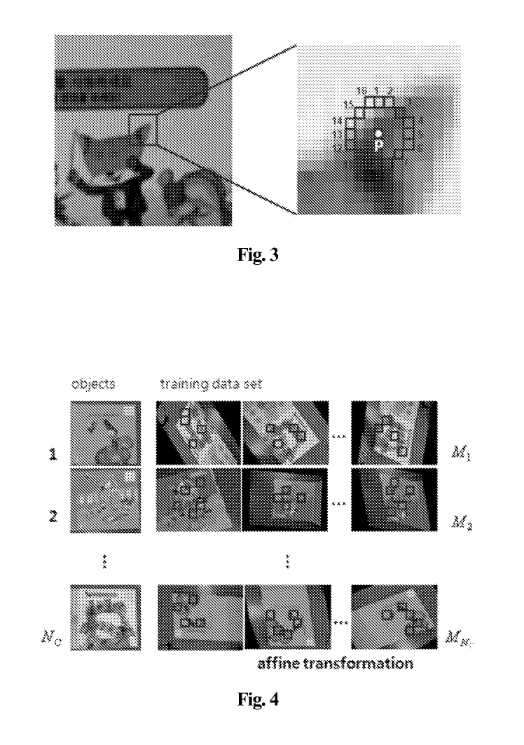

The FAST detector extracts point p as a keypoint if 12 (for example, 75%) or more successive pixels of 16 pixels adjacent to the point p are brighter or darker than the point p, with respect to the 16 pixels (brightness is taken into consideration) constituting a circle having a radius of 3 around the point p, as shown in FIG. 3.

The keypoint extraction unit extracts a keypoint region, that is, an image patch, including 32*32 pixels, around each extracted keypoint.

Training Unit

The training unit 13 performs training on training target object images at a training step, and includes an object recognition training unit and a keypoint training unit.

The object recognition training unit creates images from new viewpoints by randomly applying affine transformations to each training target object image. FIG. 4 is a diagram showing training data sets obtained for respective images of training target objects by randomly performing affine transformations on Nc training target object images. The training data sets are referred to as M₁, M₂, . . . , and M_{Nc}, respectively. 32*32 keypoint regions around keypoints are extracted from images of each training data set.

In the example of FIG. 4, four keypoints are extracted from an image of a first training target object, and, if images are acquired from a plurality of new viewpoints by affine transformation, four keypoint regions are acquired from each of the newly acquired images. All keypoint regions obtained from all training data sets for a single training target object image become training targets. The image patches of all keypoints are applied to all randomized trees of an extended randomized forest. Then each of the keypoint regions is matched to a single leaf node through nodes of each randomized tree.

If a keypoint region extracted from an i-th (here, ‘i’ is a class number assigned to the object) object reaches and is then matched to the first leaf node ξ_{t,l} of a t-th tree Tt, the frequency of the corresponding object class I of the posterior probability distribution set stored at the leaf node ξ_{t,l} is increased. As a result, the total number of keypoints matched to each leaf node and the frequency of an object class to which the keypoints matched to the leaf node belong are stored at the leaf node. If the total number of matched keypoints of the leaf node ξ_{t,l} is N_{t,l} and the frequency of the object class i is N_{t,l,i} the posterior probability distribution of the corresponding object class i at the leaf node ξ_{t,l} may be expressed by the following Equation 1:

$$P ( C = i \vert {ξ}_{t , l} ) = \frac{{N}_{t , l , i}}{{N}_{t , l}} \qquad ( 1 )$$

A posterior probability distribution value calculated for each object class is stored at each leaf node.

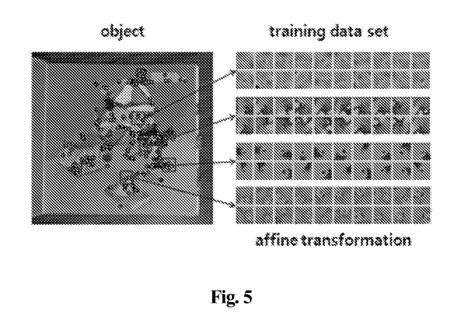

Next, the keypoint training unit will be described. The keypoint training unit acquires image patches of the 32*32 keypoint regions extracted from the original image of a training target object by the keypoint extraction unit, and creates training data sets by performing affine transformations on respective keypoint regions, as shown in FIG. 5. When training data sets for all keypoint regions of an arbitrary object are completed, the image patches of all keypoints included in the corresponding training data set are applied to all randomized trees of an extended randomized forest. Then each keypoint region is matched to an arbitrary leaf node of the all randomized trees.

If a k-th keypoint region extracted from an i-th object (here, ‘i’ is a class number assigned to an object) reaches and is matched to a first leaf node ξ_{t,l} of a t-th tree Tt, the frequency of a corresponding keypoint class k of the posterior probability distribution set of an i-th object stored at the leaf node is increased. As a result, the total number of keypoints matched to the leaf node and the frequency of the keypoint class matched to the leaf node are stored at the leaf node. If the total number of matched keypoints of the leaf node ξ_{t,l} is N_{t,l} and the frequency of the keypoint class k is N_{t,l,k}, the posterior probability distribution at the leaf node of the corresponding keypoint class k is expressed by the following Equation 2:

$$P ( K = k \vert i , {ξ}_{t , l} ) = \frac{{N}_{t , l , i}}{{N}_{t , l}} \qquad ( 2 )$$

A posterior probability distribution value calculated for each class of each object is stored at each leaf node.

The training process for keypoint matching is repeatedly performed on all objects.

As a result of the above-described training for object recognition and the above-described training for keypoint matching, each leaf node of the extended randomized forest stores one posterior probability distribution set for object recognition and Nc (here, Nc is the total number of learned objects) posterior probability distribution sets for keypoint recognition within each object, as shown in FIG. 2. That is, a total of (1+Nc) posterior probability distribution sets is stored for each leaf node.

The probabilities of a keypoint matched to the corresponding leaf node being object 1, object 2, . . . , and object Nc are stored in the object recognition posterior probability distribution set. The probabilities of the keypoint matched to the corresponding leaf node being keypoint 1 of object 1, keypoint 2, . . . , and keypoint k in the first object keypoint matching posterior probability distribution set, and the probabilities of the keypoint matched to the corresponding leaf node being keypoint 1 of object 2, keypoint 2, . . . , and keypoint k are stored in the second object keypoint matching posterior probability distribution set. In the same way, the probabilities of the keypoint matched to the corresponding leaf node being keypoint 1 of object Nc, keypoint 2, . . . , and keypoint k are stored in the Nc-th object keypoint matching posterior probability distribution set.

Matching Unit 14

When a matching target object image is input, the above-described keypoint extraction unit extracts N keypoints from the corresponding matching target object image, and then obtains N keypoint regions (image patches). Thereafter, each of the extracted keypoint regions is passed through N_{T} randomized trees constituting a previously learned extended randomized forest. When an arbitrary keypoint mⱼ is passed through N_{T} randomized trees, the keypoint mⱼ reaches one leaf node for each tree, so that the keypoint mⱼ reaches N_{T} leaf nodes finally. As a result, one object recognition posterior probability distribution set value and N_{T} keypoint matching posterior probability distribution set values can be obtained.

The matching unit 14 performs object recognition using object recognition posterior probability distribution set values, stored at matched leaf nodes, for all keypoints, and then matches the keypoints using the keypoint matching posterior probability distribution set values of the corresponding object.

As described above, an object recognition posterior probability distribution set is stored at a leaf node. This is a value indicating an object from which a keypoint matched to the corresponding leaf node has been extracted. In more detail, the probabilities of the keypoint matched to the corresponding leaf node belonging to object 1, to object 2, . . . , and, to object Nc are stored in the object recognition posterior probability distribution set.

When an arbitrary keypoint mⱼ is passed through N_{T} randomized trees, N_{T} object recognition posterior probability distribution sets are obtained. Since the probabilities of the corresponding keypoint mⱼ belonging to object 1, to object 2, . . . , and to object Nc are stored in each of the object recognition posterior probability distribution sets, N_{T} posterior probabilities of the keypoint mⱼ belonging to object i (here, i is 1, 2, . . . , and Nc) are obtained.

The average of the N_{T} posterior probabilities of the keypoint mⱼ belonging to object i (here, i is 1, 2, . . . , and Nc) is obtained. The average posterior probability of the keypoint mⱼ belonging to object i (here, i is 1, 2, . . . , and Nc) may be expressed by the following Equation 3:

$${P}_{j} = \frac{1}{{N}_{T}} {\sum }_{j = 1}^{{N}_{T}} P ( C = i \vert leaf ( {T}_{t} , {m}_{j} ) \qquad ( 3 )$$

Thereafter, N_{T} object recognition posterior probability distribution sets are obtained by applying an extended randomized forest to all keypoints, and the average posterior probability Pⱼ of a corresponding keypoint belonging to object i (here, i is 1, 2, . . . , and Nc), as shown in Equation 3, is obtained using the N_{T} object recognition posterior probability distribution sets.

Furthermore, the average value

$$\frac{1}{N} {\sum }_{j = 1}^{N} {P}_{j}$$

of the average posterior probabilities of belonging to the object i (here, i is 1, 2, . . . , and Nc) calculated for the obtained all keypoints is obtained, and an object class having the greatest average value of the average posterior probabilities is recognized as an object included in the matching target object image. This may be expressed by the following Equation 4:

$$\begin{matrix}Object \hat{i} = arg {max}_{i} P ( C = i \vert {T}_{1} , … , {T}_{{N}_{T}} , {m}_{1} , … , {m}_{{N}_{c}} ) \\ = arg {max}_{i} \frac{1}{N} {\sum }_{j = 1}^{N} \frac{1}{{N}_{T}} {\sum }_{t = 1}^{{N}_{T}} P ( C = i \vert leaf ( {T}_{t} , {m}_{j} ) )\end{matrix} \qquad ( 4 )$$

After the recognition of the object, keypoint matching is performed. Since all keypoints are matched to leaf nodes by applying all randomized trees to the keypoints, the keypoint matching posterior probability distribution sets of the recognized object are obtained from the matched leaf nodes. For example, if the class of the object recognized in the object recognition process is No. 2, a second object keypoint matching posterior probability distribution set stored at each leaf node is obtained. Since the probability of the corresponding keypoint belonging to keypoint 1 of object 2, the probability of belonging to keypoint 2, . . . , and the probability of belonging to keypoint N are stored in the second object keypoint matching posterior probability distribution set, N_{T} posterior probabilities of the corresponding keypoint belonging to respective keypoints of object 2 are obtained finally. In the same manner as in the above-described object recognition process, the posterior probabilities of belonging to an arbitrary keypoint of the recognized object are averaged for each of the N keypoints extracted from the matching target object image, and then a keypoint class having the greatest average posterior probability is matched to the corresponding keypoint. This may be expressed by the following Equation 5:

$$\begin{matrix}Keypoint \hat{k} = arg {max}_{k} P ( K = k \vert {T}_{1} , … , {T}_{{N}_{T}} , {m}_{j} ) \\ = arg {max}_{k} \frac{1}{{N}_{T}} {\sum }_{t = 1}^{{N}_{T}} P ( K = k \vert leaf ( {T}_{t} , {m}_{j} ) )\end{matrix} \qquad ( 5 )$$

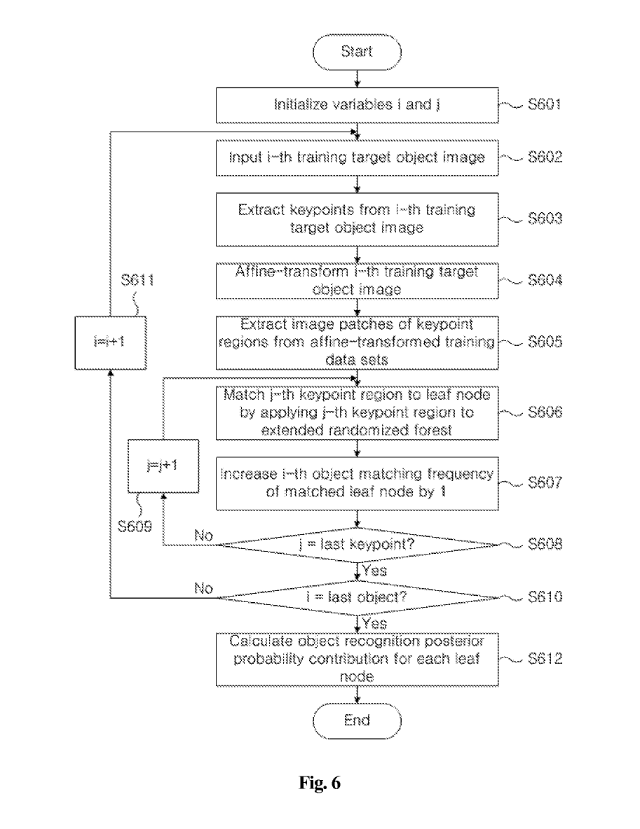

FIG. 6 is a flowchart showing a process of training objects using training target object images according to the present invention.

First, the variables i and j are initialized to 1 at step S601. An i-th training target object image including an i-th object to be learned is received at step S602. Keypoints are extracted from the i-th training target object image by applying the i-th training target object image to an FAST detector at step S603. Thereafter, various training data sets of images are obtained from new viewpoints by randomly performing a plurality of affine transformations on the i-th training target object image at step S604. The image patches of the keypoint regions are extracted from the affine-transformed training data sets of images at step S605.

Thereafter, an j-th keypoint region is made to be matched to a single leaf node for each tree by applying the j-th keypoint region to respective randomized trees of an extended randomized forest at step S606. Then the i-th object matching frequency of the matched leaf to node is increased by 1 at step S607. Whether j is the last keypoint is determined at step S608, and the process returns to step S606 while increasing j by 1 at step S609.

Furthermore, whether i is the last object is determined at step S610, and the process returns to step S602 while increasing i by 1 at step S611.

That is, the corresponding object matching frequencies of matched leaf nodes are accumulated by applying an extended randomized forest to each of image patches of all keypoint regions obtained by performing affine transformations on training target object images of all objects to be learned.

When the object matching frequencies have been accumulated for all keypoint regions of all objects, object recognition posterior probability distributions are calculated for respective leaf nodes at step S611.

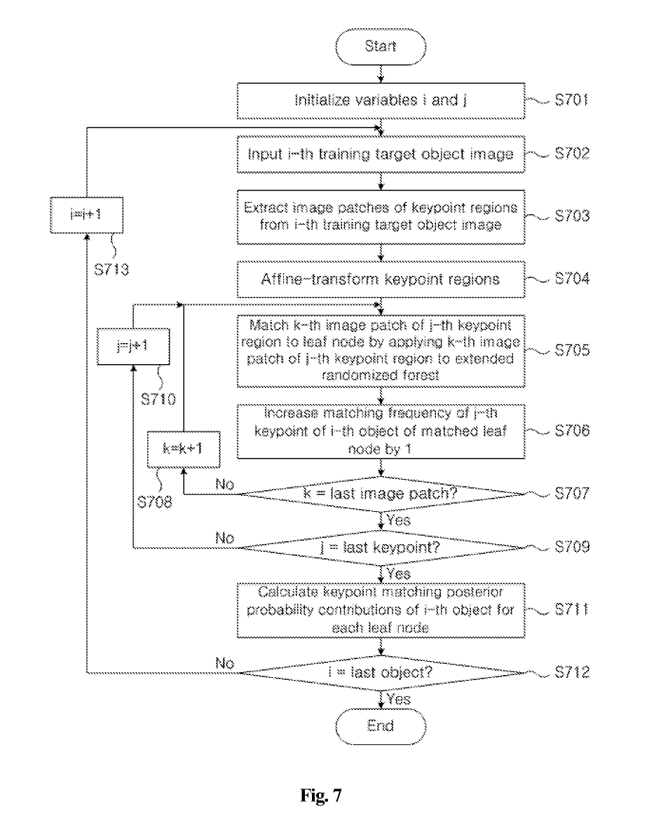

FIG. 7 is a flowchart showing a process of training the keypoints of objects using training target object images according to the present invention.

First, the variables i, j and k are initialized to 1 at step S701. An i-th training target object image including an i-th object to be learned is received at step S702. The image patches of keypoint regions are extracted from the i-th training target object image by applying the i-th training target object image to a FAST detector at step S703. Thereafter, various training data sets of image patches are obtained from new viewpoints by randomly performing a plurality of affine transformations on respective image patches of the keypoint regions at step S704.

Thereafter, the k-th image patch of the j-th keypoint region is matched to a single leaf node for each tree by applying the k-th image patch to each randomized tree of an extended randomized forest at step S705. Then the matching frequency of the j-th keypoint of the i-th object of the matched leaf node is increased by 1 at step S706. Whether k is the last image patch is determined at step S707, and the process returns to step S705 while increasing k by 1 at step S708. Furthermore, whether j is the last keypoint is determined at step S709, and the process returns to step S705 while increasing j by 1 at step S710.

That is, keypoints are extracted from a training target object image of an arbitrary object, and the matching frequencies of the corresponding keypoints of the corresponding object of the matched leaf nodes are accumulated by applying extended randomized forests to all image patches of all keypoints obtained by performing affine transformations on respective images patches of the keypoint regions.

When all keypoint matching frequencies have been accumulated for all image patches of to all keypoints of the i-th object, the keypoint matching posterior probability distributions of the i-th object are calculated for the respective leaf nodes at step S711. Whether i is the last object is determined at step S712, and the process returns to step S702 while increasing i by 1 at step S713. By doing this, keypoint matching posterior probability distribution for all objects are learned.

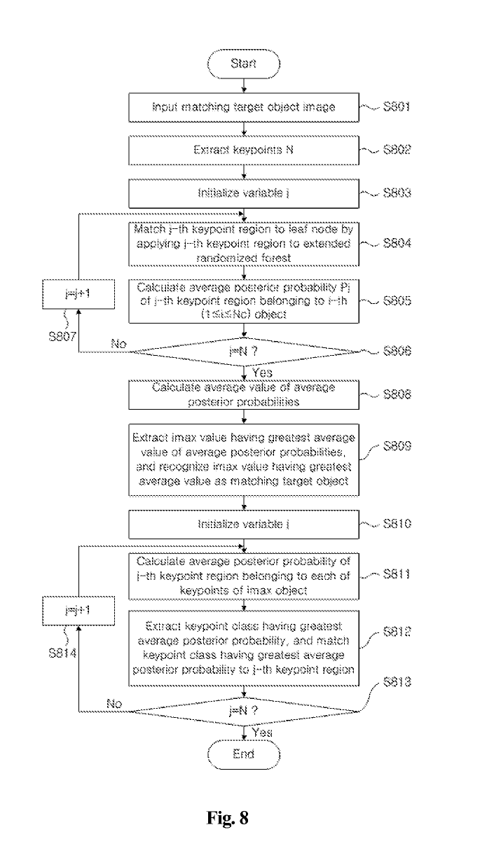

FIG. 8 is a flowchart showing a process of recognizing an object included in a matching target object image and matching keypoints according to the present invention.

When a matching target object image is input at step S801, an object is recognized for the matching target object image, and the keypoints of the corresponding recognized object are matched. First, the keypoints are extracted by applying the corresponding matching target object image to a FAST detector at step S802. In this case, the number of extracted keypoints is N.

The variable j is initialized to 1 at step S803, and a j-th keypoint region is matched to a leaf node for each randomized tree by applying the j-th keypoint region to an extended randomized forest at step S804. The average posterior probability Pj of the j-th keypoint region belonging an i-th (here, 1≦i≦Nc) object is calculated using the object recognition posterior probability distribution of each matched leaf node at step S805. Whether j is N is determined at step S806, and the process repeats steps S804 and S805 while increasing j by 1 at step S807.

The average value

$$\frac{1}{N} {\sum }_{j = 1}^{N} {P}_{j}$$

of the average posterior probabilities Pⱼ obtained for all keypoint regions is calculated at step S808, and imax for which the average value of the average posterior probabilities is greatest is extracted and then recognized as the matching target object at step S809. By doing this, the object included in the matching target object image is recognized.

Thereafter, in order to match the keypoints of the object, the variable j is initialized at step S810. At step S811, the average posterior probability of the imax object of each leaf belonging to each of the keypoints using the keypoint matching posterior probability distribution of the imax object of the leaf node matched at step S804. A keypoint having the greatest average posterior probability is extracted and then matched to the j-th keypoint region at step S812. Whether j is N is determined at step S813, and the process repeats steps S811 and S812 while increasing j by 1 at step S814.

### EXPERIMENTAL RESULTS

Experiments for applying to an Augmented Reality (AR) Book which belongs to augmented reality application programs requiring real time were carried out so as to determine whether object recognition using an extended randomized forest proposed by the present invention operates appropriately. For the experiments, a notebook computer equipped with 2.2 GHz core 2 duo CPU, 2 GB memory, and ATI mobility Radeon HD 2400 graphic card was used, and Logiteck's ultra-webcam was used. An image of 640×480 size was received from the webcam, and the keypoints of the input image were extracted using a FAST detector. The extended randomized forest included N_{T}=40 randomized trees, and each of the trees was depth d=10.

Prior to the experiments, it is necessary to evaluate the recognition performance of an object recognizer using the extended randomized forest proposed by the present invention. Accordingly, 20 pages were made to be recognized by causing the extended randomized forest to conduct training using 20 pages, a training image and other 9 test images were prepared, and 9 images made through synthesis from different viewpoints were created by performing affine transformations on the respective test images. As a result, a total of 180 test images were prepared for the performance tests.

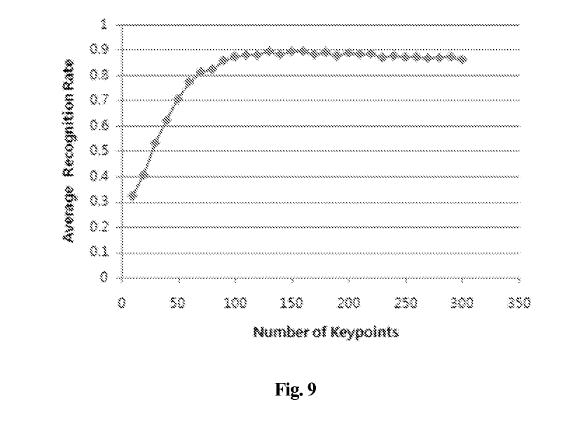

In order to find the number of keypoints which should be extracted per page to represent a corresponding object desirably at the step of training an extended randomized forest, the recognition performance was tested while the number of keypoints to be extracted per page was sequentially increased from 10 to 300. FIG. 9 is a graph illustrating the results of performance tests. According to the test results, when about 100 keypoints were extracted, the recognition rate was about 89%. Even when more keypoints were extracted, the recognition rate converged to about 90%.

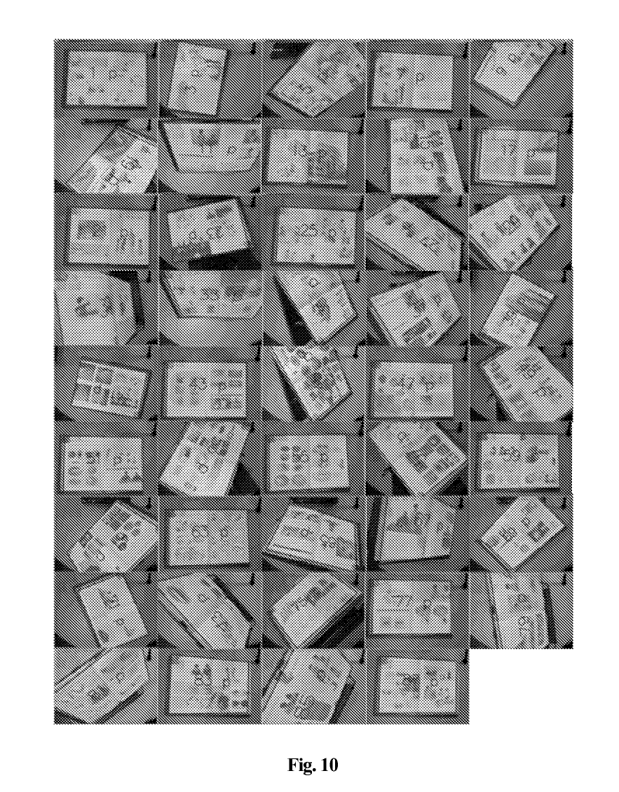

FIG. 10 is a diagram showing images of 44 pages used for 3D object recognition tests. The identifier (ID) of each of recognized pages was added to the recognized page to enable the checking of the correct recognition of the page, and the frame of the recognized page was projected onto a corresponding image in the estimated position of a camera to enable the checking of the correct estimation of the position of the page. From FIG. 10, it can be seen that 44 pages have been correctly recognized and the positions of the pages have been correctly estimated through keypoint matching.

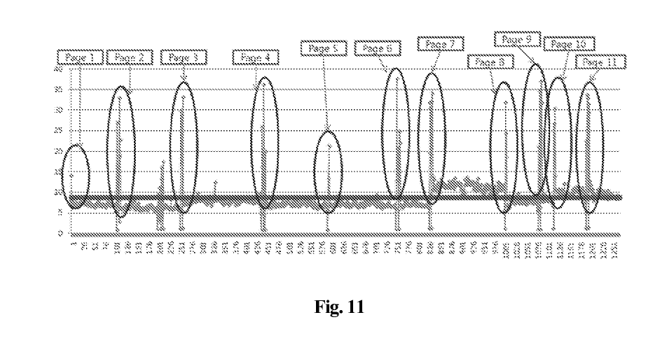

FIG. 11 is a graph illustrating the times required for the sequential recognition of a book including 11 pages. The portions indicated by ellipses in FIG. 11 are the portions on which 3D object recognition proposed by the present invention has been performed. The average 3D to recognition time for 11 pages is about 30 ms (33 fps), from which it can be seen that the recognition time is sufficient to guarantee real-time processing.

The core principles of the present invention may be represented by the following three principles:

First, although the conventional randomized forest enables keypoint matching, the present invention is configured to simultaneously perform both object recognition and keypoint matching by extending the conventional randomized forest.

Second, all posterior probability distributions which can be used to perform two tasks are stored at a leaf node of a randomized tree of an extended randomized forest, both object recognition and keypoint matching can be simultaneously performed even when a keypoint is passed through the extended randomized forest once.

Third, the present invention can be effectively used for systems requiring real-time processing, such as augmented-reality systems, because the present invention can reduce the matching time.

The present invention may be applied to all fields which require keypoint-based 3D object recognition. That is, the present invention may be applied not only to intelligent robot fields requiring object recognition and the security-related fields, such as user authentication systems requiring facial recognition and intelligent surveillance systems, but also to many industrial fields requiring 3D object recognition, such as intelligent electronic appliance products and education and advertisement using augmented reality technology.

The above-described present invention has the advantage of being usefully applied to real-time systems because the time required for 3D object recognition can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A three-dimensional (3D) object recognition system, comprising:
a storage unit configured to store an extended randomized forest in which a plurality of randomized trees is included and each of the randomized trees includes a plurality of leaf nodes;
a training unit configured to extract a plurality of keypoints from a training target object image input for each of a plurality of training target objects, calculate an object recognition posterior probability distribution and training target object-based keypoint matching posterior probability distributions for each of the leaf nodes by applying the extracted keypoints to the extended randomized forest, and store them in the storage unit; and
a matching unit configured to extract a plurality of keypoints from a matching target object image, match the extracted keypoints to a plurality of leaf nodes by applying the extracted keypoints to the extended randomized forest, recognize an object included in the matching target object image using the object recognition posterior probability distributions stored at the matched leaf nodes, and match the keypoints extracted from the matching target object image to keypoints of the recognized object using training target object-based keypoint matching posterior probability distributions stored at the matched leaf nodes.

2. The 3D object recognition system as set forth in claim 1, wherein the training unit is configured to affine-transform the training target object image into a plurality of images and further extract a plurality of keypoints from the affine-transformed images.

3. The 3D object recognition system as set forth in claim 1, wherein the training unit is configured to affine-transform the keypoints, extracted from the training target object image, into a plurality of images.

4. A 3D object recognition system, comprising:
a storage unit configured to store an extended randomized forest in which a plurality of randomized trees is included, each of the randomized trees includes a plurality of leaf nodes, and an object recognition posterior probability distribution and training target object-based keypoint matching posterior probability distributions are stored for each of the leaf nodes; and
a matching configured to match a plurality of keypoints, extracted from a matching target object image, to a plurality of leaf nodes by applying the extracted keypoints to the extended randomized forest, recognize an object included in the matching target object image using object recognition posterior probability distributions stored at the matched leaf nodes, and match the keypoints, extracted from the matching target object image, to keypoints of the recognized object using training target object-based keypoint matching posterior probability distributions stored at the matched leaf nodes.

5. A 3D object recognition method for a 3D object recognition system including an extended randomized forest in which a plurality of randomized trees is included and each of the randomized trees includes a plurality of leaf nodes, the method comprising;
a training step of extracting a plurality of keypoints from a training target object image input for each of a plurality of training target objects, and calculating and storing an object recognition posterior probability distribution and training target object-based keypoint matching posterior probability distributions for each of the leaf nodes by applying the extracted keypoints to the extended randomized forest; and
a matching step of matching a plurality of keypoints, extracted from a matching target object image, to a plurality of leaf nodes by applying the extracted keypoints to the extended randomized forest, recognizing an object included in the matching target object image using object recognition posterior probability distributions stored at the matched leaf nodes, and matching the keypoints extracted from the matching target object image to keypoints of the recognized object using training target object-based keypoint matching posterior probability distributions stored at the matched leaf nodes.

6. The 3D object recognition method as set forth in claim 5, wherein the training step further comprises:
(a) creating a plurality of affine-transformed images from a plurality of different viewpoints by performing a plurality of affine transformations on the training target object image;
(b) extracting image patches of a plurality of keypoints from the affine-transformed images from the different viewpoints;
(c) matching each of the image patches to a single leaf for each of the randomized trees by applying the image patches to the randomized trees of the extended randomized forest, and increasing a frequency of the training target object at the matched leaf node; and
(d) repeating steps (a)-(c) for training target object images input for the training target objects, and calculating the object recognition posterior probability distribution for each of all leaf nodes constituting the extended randomized forest.

7. The 3D object recognition method as set forth in claim 6, wherein the training step further comprises:
sixth step of (e) creating the affine-transformed image patches from the different viewpoints by performing a plurality of affine transformations on each of image patches of the keypoints of the training target object image extracted at the first step;
(f) matching each of the created image patches to a single leaf node for each of the randomized trees by applying the created image patches to the randomized trees of the extended randomized forest, and increasing a corresponding keypoint matching frequency of the training target object at the matched leaf node; and
(g) repeating steps (e)-(f) for all keypoint regions of the training target object image, and then calculating the keypoint matching posterior probability distributions of the training target object for each of all leaf nodes of the extended randomized forest.

8. A 3D object recognition method for a 3D object recognition system including an extended randomized forest in which a plurality of randomized trees is included, each of the randomized trees includes a plurality of leaf nodes, and an object recognition posterior probability distribution and training target object-based keypoint matching posterior probability distributions are stored for each of the leaf nodes, the method comprising:
matching a plurality of keypoints, extracted from a matching target object image, to a plurality of leaf nodes by applying the extracted keypoints to the extended randomized forest;
recognizing an object included in the matching target object image using object recognition posterior probability distributions stored at the matched leaf nodes; and
matching the keypoints, extracted from the matching target object image, to keypoints of the recognized object using training target object-based keypoint matching posterior probability distributions stored at the matched leaf nodes.

9. The 3D object recognition method as set forth in claim 5, wherein the step of recognizing an object included in the matching target object image comprises the steps of:
calculating average values of the posterior probabilities of the keypoints extracted from the matching target object image belonging to the object using the object recognition posterior probability distributions stored at the matched leaf nodes, and recognizing an object class having a greatest average value of the posterior probabilities as the object included in the matching target object image.

10. The 3D object recognition method as set forth in claim 5, wherein the step of matching the keypoints extracted from the matching target object image comprises:
calculating an average posterior probability of a certain keypoint extracted from the matching target object image belonging to each of keypoints of the recognized object using the keypoint matching posterior probability distributions of the recognized object stored at the matched leaf nodes, extracting a keypoint of the recognized object having a greatest average posterior probability, and matching the keypoint having a greatest average posterior probability to a keypoint extracted from the matching target object image.

11. A training method for 3D object recognition for a 3D object recognition system including an extended randomized forest in which a plurality of randomized trees is included and each of the randomized trees includes a plurality of leaf nodes, the method comprising;
extracting a plurality of keypoints from a training target object image input for each of a plurality of training target objects; and
calculating an object recognition posterior probability distribution and training target object-based keypoint matching posterior probability distributions for each of the leaf nodes by applying the extracted keypoints to the extended randomized forest.

12. The training method for 3D object recognition as set forth in claim 11, wherein the step of calculating an object recognition posterior probability distribution for each of the leaf nodes comprises:
(a) creating a plurality of affine-transformed images from a plurality of different viewpoints by performing a plurality of affine transformations on the training target object image;
(b) extracting image patches of a plurality of keypoints from the affine-transformed images from the different viewpoints;
(c) matching each of the image patches to a single leaf for each of the randomized trees by applying the image patches to the randomized trees of the extended randomized forest, and increasing a matching frequency of the training target object at the matched leaf node; and
(d) repeating steps (a)-(c) for training target object images input for the training target objects, and calculating the object recognition posterior probability distribution for each of all leaf nodes constituting the extended randomized forest.

13. The training method for 3D object recognition as set forth in claim 12, wherein the step of calculating training target object-based keypoint matching posterior probability distributions for each of the leaf nodes further comprises:
(e) creating the affine-transformed image patches from the different viewpoints by performing a plurality of affine transformations on each of image patches of the keypoints of the training target object image extracted at the first step;
(f) matching each of the created image patches to a single leaf node for each of the randomized trees by applying the created image patches to the randomized trees of the extended randomized forest, and increasing a corresponding keypoint matching frequency of the training target object at the matched leaf node; and
(g) repeating steps (e)-(f) for all keypoint regions of the training target object image, and then calculating the keypoint matching posterior probability distributions of the training target object for each of all leaf nodes constituting the extended randomized forest.
